(19) United States
(12) Patent Application Publication
(10) Pub. No.: US 2025/0296188 A1
(43) Pub. Date: Sep. 25, 2025

(54) SYSTEM AND METHOD OF ASSESSING HEALTH STATUS OF MANUFACTURING EQUIPMENT

(71) Applicant: InnoLux Corporation, Miao-Li County (TW)

(72) Inventors: Yung-Hua CHANG, Miao-Li County (TW); Tzu-Cheng LEE, Miao-Li County (TW)

(73) Assignee: InnoLux Corporation, Miao-Li County (TW)

(21) Appl. No.: 19/052,225

(22) Filed: Feb. 12, 2025

(30) Foreign Application Priority Data
Mar. 20, 2024 (CN) 202410318270.0

(51) Int. Cl. B23Q 17/00

(52) U.S. Cl. CPC B23Q 17/008

(57) ABSTRACT

A system of assessing health status of manufacturing equipment includes codebook database, historical data database, a modeling server and an edge computing server. The codebook database stores multiple monitor parameter of the manufacturing equipment in each manufacturing process. The historical data database stores instant high-frequency data of all parameters of the manufacturing equipment, thereby providing historical high-frequency data of all parameters of the manufacturing equipment. The modeling database accesses historical high-frequency data of multiple monitor parameters from the historical data database according to the codebook data and extracts characteristics of the historical high-frequency data of multiple monitor parameters for constructing the health model of the manufacturing equipment. The edge computing server analyzes the instant high-frequency data uploaded by the manufacturing equipment during a current manufacturing process and the health model on a real-time basis, thereby generating a health index score of the manufacturing equipment during the current manufacturing process.

### BACKGROUND OF THE DISCLOSURE

### 1. Field of the Disclosure

The present disclosure is related to a system and a method of assessing health status of manufacturing equipment, and more particularly, to a system and a method of assessing health status of manufacturing equipment by monitoring the instant status of manufacturing process at each station.

### 2. Description of the Prior Art

During semiconductor manufacturing process, material variations, setting deviations of the manufacturing equipment, environmental disturbance and/or insistent operational methods, the final products may have performance variations. The motivation for implementing process control is to improve the device yield by controlling processes and machines to collect information, reduce the process variability, and increase the equipment efficiency.

In the prior-art process control method, a defective device produced by an abnormal current station can only be detected at the next inspection station, or the functionality of the entire manufacturing process is reviewed only when detecting a defective final product. Therefore, there is a need of a system and a method of assessing health status of manufacturing equipment by monitoring the instant status of manufacturing process at each station.

### SUMMARY OF THE DISCLOSURE

The present invention provides a system of assessing health status of manufacturing equipment which includes a codebook database, a historical data database, a modeling server and an edge computing server. The codebook database is configured to store a codebook data which is associated with multiple monitor parameters of a piece of manufacturing equipment during each manufacturing process. The historical data database is configured to store instant high-frequency data of all parameters of the piece of manufacturing equipment, thereby providing historical high-frequency data of all parameters of the piece of manufacturing equipment. The modeling server is configured to access the historical high-frequency data of the multiple monitor parameters from the historical data database according to the codebook data and extract characteristics of the historical high-frequency data of the multiple monitor parameters for constructing a health model of the piece of manufacturing equipment. The edge computing server is configured to analyze the instant high-frequency data uploaded by the piece of manufacturing equipment during a current manufacturing process and the health model on a real-time basis, thereby generating a health index score of the piece of manufacturing equipment during the current manufacturing process.

The present invention also provides a method of assessing health status of manufacturing equipment. The method includes setting a codebook data associated with multiple monitor parameters of a piece of manufacturing equipment during each manufacturing process, storing instant high-frequency data of all parameters of the piece of manufacturing equipment for providing historical high-frequency data of all parameters of the piece of manufacturing equipment, accessing the historical high-frequency data of the multiple monitor parameters from the historical data database according to the codebook data and extracting characteristics of the historical high-frequency data of the multiple monitor parameters for constructing a health model of the piece of manufacturing equipment, and analyzing the instant high-frequency data uploaded by the piece of manufacturing equipment during a current manufacturing process and the health model on a real-time basis for generating a health index score of the piece of manufacturing equipment during the current manufacturing process.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 is a function diagram illustrating a system of assessing the health status of manufacturing equipment according to an embodiment of the present disclosure.

FIG. 2 is a function diagram illustrating a system of assessing the health status of manufacturing equipment according to another embodiment of the present disclosure.

FIG. 3 is a function diagram illustrating a system of assessing the health status of manufacturing equipment according to yet another embodiment of the present disclosure.

FIG. 4 is a flowchart illustrating a method of assessing the health status of manufacturing equipment according to an embodiment of the present disclosure.

### DETAILED DESCRIPTION

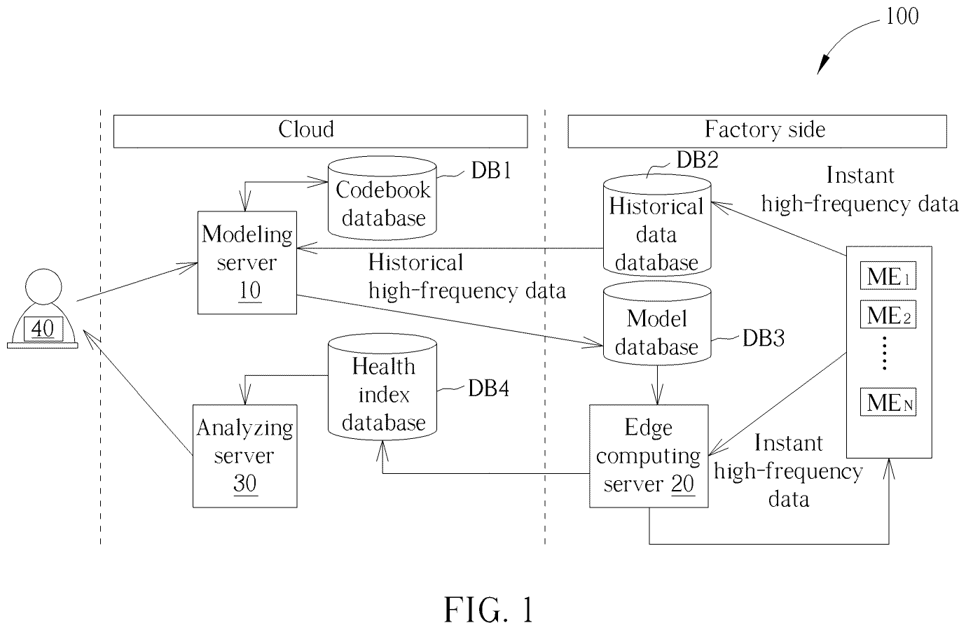

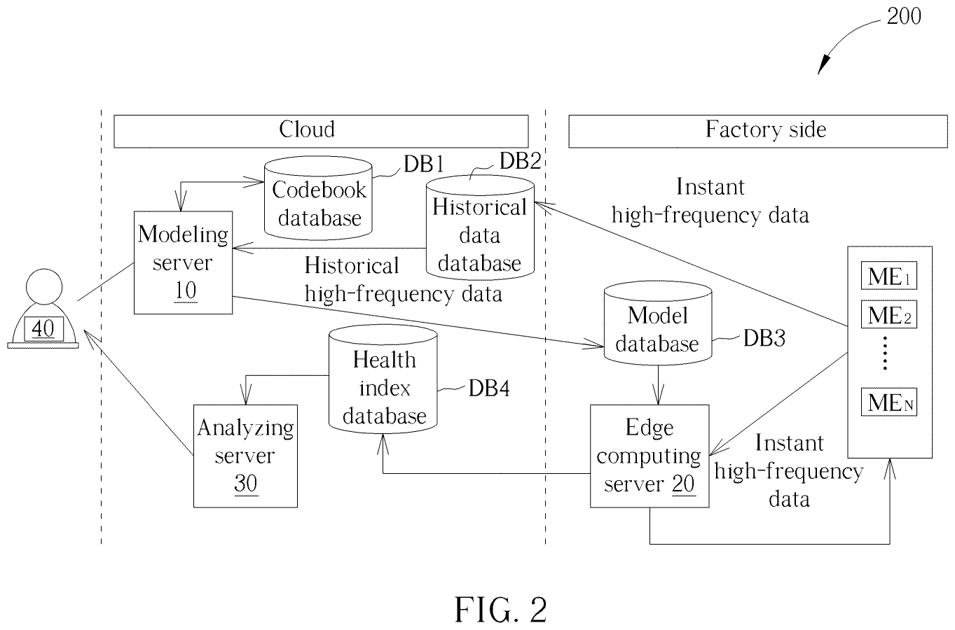

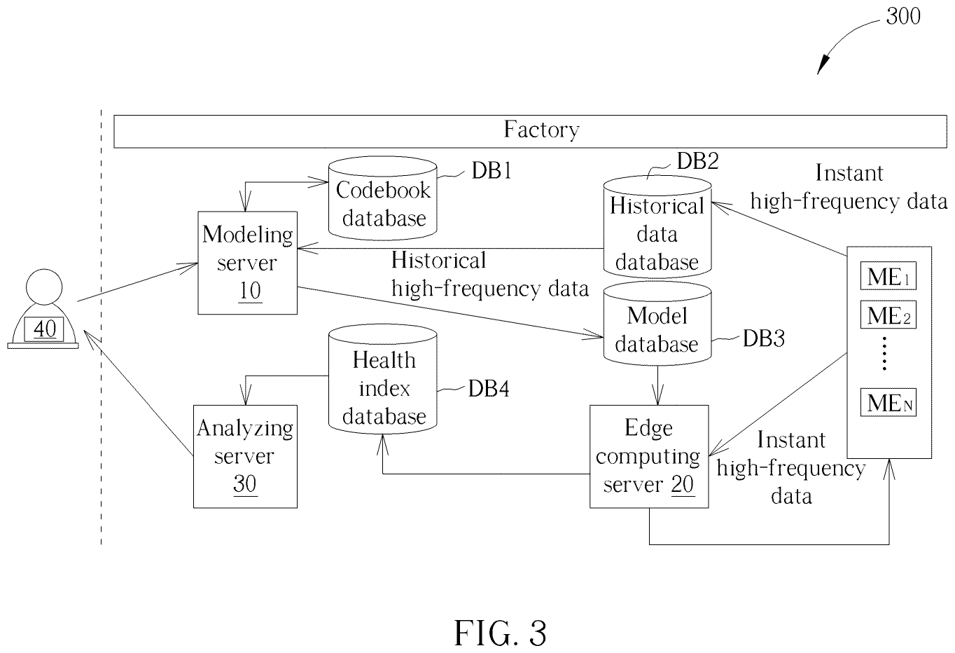

FIG. 1 is a function diagram illustrating a system 100 of assessing the health status of manufacturing equipment according to an embodiment of the present disclosure. FIG. 2 is a function diagram illustrating a system 200 of assessing the health status of manufacturing equipment according to another embodiment of the present disclosure. FIG. 3 is a function diagram illustrating a system 300 of assessing the health status of manufacturing equipment according to yet another embodiment of the present disclosure. Each of the system 100, 200 and 300 is configured to monitor the health status of manufacturing equipment ME₁-ME_{N}, wherein N is a positive integer. Each of the system 100, 200 and 300 includes a modeling server 10, an edge computing server 20, an analyzing server 30, a codebook database DB1, a historical data database DB2, a model database DB3, and a health index database DB4. The codebook database DB1 is configured to store codebook data which is associated with multiple monitor parameters of the manufacturing equipment ME₁-ME_{N} during each manufacturing process. The historical data database DB2 is configured to store instant high-frequency data of all parameters of the manufacturing equipment ME₁-ME_{N}, thereby providing historical high-frequency data of all parameters of the manufacturing equipment ME₁-ME_{N}. The modeling server DB3 is configured to store the health models of the manufacturing equipment ME₁-ME_{N}. The modeling server 10 is configured to access corresponding historical high-frequency data of the multiple monitor parameters from the historical data database DB2 according to the codebook data and extract characteristics of the historical high-frequency data of multiple monitor parameters for constructing the health model of each piece of manufacturing equipment. The edge computing server 20 is configured to analyze the instant high-frequency data uploaded by each piece of manufacturing equipment during each manufacturing process and the health model on a real-time basis, thereby generating a health index score of each piece of manufacturing equipment during each manufacturing process. The health index database DB4 is configured to store the health index score of each piece of manufacturing equipment. The analyzing server 30 is configured to determine whether the health index score of each piece of manufacturing equipment is qualified and perform a reason analysis when determining that the health index score of a specific piece of manufacturing equipment is not qualified. Next, the analyzing server 30 may upload the analyzing results to a terminal device 40 (such as a computer, a smartphone or a tablet) so as to inform a user of the abnormal status of the specific piece of manufacturing equipment.

In the embodiment depicted in FIG. 1, the modeling server 10, the analyzing server 30, the codebook database DB1 and the health index database DB4 are disposed on a cloud, while the edge computing server 20, the historical data database DB2, the model database DB3 and the manufacturing equipment ME₁-ME_{N} are disposed on a factory side. The factory side may include one or multiple factories. In an embodiment, all pieces of manufacturing equipment ME₁-ME_{N} are disposed in the same factory and have access to the common resources of the edge computing server 20, the historical data database DB2, and the model database DB3, as well as the cloud services of modeling and analyzing. For example, in addition to the manufacturing equipment ME₁-ME_{N}, the edge computing server 20, the historical data database DB2, and the model database DB3 are also disposed in the same factory. In another embodiment, all pieces of manufacturing equipment ME₁-ME_{N} are disposed in multiple factories which have access to the common resources of the edge computing server 20, the historical data database DB2 and the model database DB3, as well as the cloud services of modeling and analyzing. For example, each of the multiple factories accommodates the manufacturing equipment ME₁-ME_{N}, and one of the multiple factories accommodates the edge computing server 20, the historical data database DB2 and the model database DB3 accessible to other factories.

In the embodiment depicted in FIG. 2, the modeling server 10, the analyzing server 30, the codebook database DB1, the historical data database DB2 and the health index database DB4 are disposed on a cloud, while the edge computing server 20, the model database DB3 and the manufacturing equipment ME₁-ME_{N} are disposed on a factory side. The factory side may include one or multiple factories. In an embodiment, all pieces of manufacturing equipment ME₁-ME_{N} are disposed in the same factory and have access to the common resources of the edge computing server 20 and the model database DB3, as well as the cloud services of instant high-frequency data storage, historical high-frequency data storage, modeling and analyzing. For example, in addition to the manufacturing equipment ME₁-ME_{N}, the same factory also accommodates the edge computing server 20 and the model database DB3. In another embodiment, all pieces of manufacturing equipment ME₁-ME_{N} are disposed in multiple factories which have access to the common resources of the edge computing server 20 and the model database DB3, as well as the cloud services of instant high-frequency data storage, historical high-frequency data storage, modeling and analyzing. For example, each of the multiple factories accommodates the manufacturing equipment ME₁-ME_{N}, and one of the multiple factories accommodates the edge computing server 20 and the model database DB3 accessible to other factories.

In the embodiment depicted in FIG. 3, the modeling server 10, the edge computing server 20, the analyzing server 30, the codebook database DB1, the historical data database DB2, the model database DB3, the health index database DB4 and the manufacturing equipment ME₁-ME_{N} are disposed in the same factory. The factory can manage the operation of the manufacturing equipment ME₁-ME_{N} independently and all instant high-frequency data storage, historical high-frequency data storage, modeling and analyzing services are performed in the factory, thereby capable of increasing data confidentiality and security.

In the embodiments of the present disclosure, the modeling server 10, the edge computing server 20, the analyzing server 30 may include devices capable of storing, processing and analyzing data, such as a motherboard, a central processing unit, memory, a chipset, a hard dive, a network card and a power source. However, the implementation of each server does not limit the scope of the present invention.

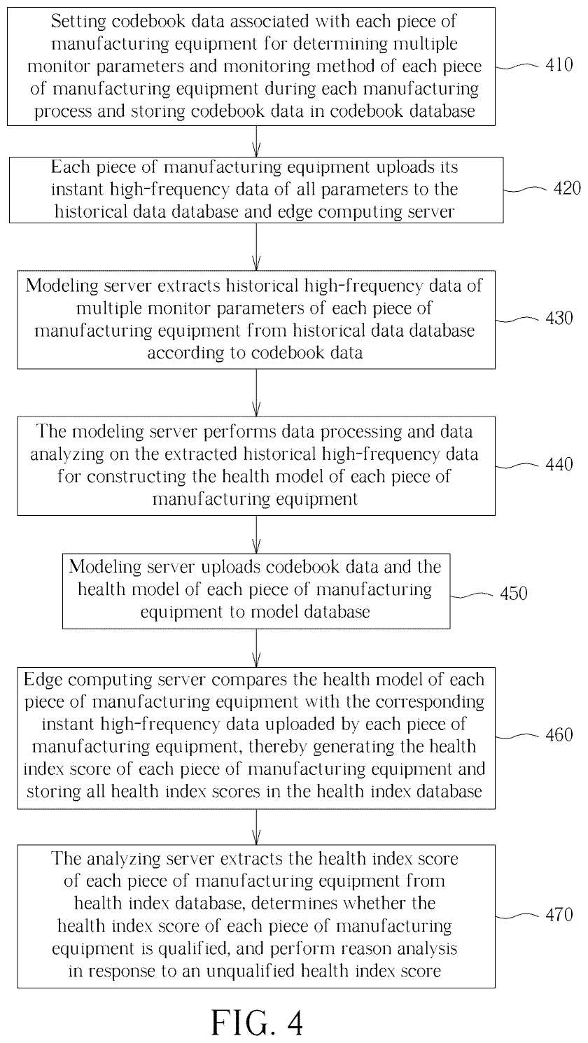

FIG. 4 is a flowchart illustrating a method of assessing the health status of manufacturing equipment according to an embodiment of the present disclosure. The flowchart in FIG. 4 includes the following steps:

Step 410: setting codebook data associated with each piece of manufacturing equipment for determining multiple monitor parameters and a monitoring method of each piece of manufacturing equipment during each manufacturing process and storing the codebook data in the codebook database DB1.

Step 420: each piece of manufacturing equipment uploads its instant high-frequency data of all parameters to the historical data database DB2 and the edge computing server 20.

Step 430: the modeling server 10 extracts the historical high-frequency data of multiple monitor parameters of each piece of manufacturing equipment from the historical data database DB2 according to the codebook data.

Step 440: the modeling server 10 performs data processing and data analyzing on the extracted historical high-frequency data for constructing the health model of each piece of manufacturing equipment.

Step 450: the modeling server 10 uploads the codebook data and the health model of each piece of manufacturing equipment to the model database DB3.

Step 460: the edge computing server 20 compares the health model of each piece of manufacturing equipment with the corresponding instant high-frequency data uploaded by each piece of manufacturing equipment, thereby generating the health index score of each piece of manufacturing equipment and storing all health index scores in the health index database DB4.

Step 470: the analyzing server 30 extracts the health index score of each piece of manufacturing equipment from the health index database DB4, determines whether the health index score of each piece of manufacturing equipment is qualified, and perform a reason analysis in response to an unqualified health index score.

As well known to those skilled in the art, various parameters of manufacturing equipment may be set according to each manufacturing process. Since the manufacturing processes may have different lengths, individual monitoring of each parameter and each length of different manufacturing processes is time-consuming. Also, it is difficult to monitor the correlation between different parameters by monitoring each parameter individually, and the user is thus unable to identify relevant parameters which affect the health status of manufacturing equipment. Therefore in step 410 of the present disclosure, the user may set the codebook data associated of each piece of manufacturing equipment based on personal experience or historical experience for determining the multiple monitor parameters and the monitoring method of each piece of manufacturing equipment during each manufacturing process. However, the method of setting the codebook data does not limit the scope of the present disclosure.

In an embodiment of the present disclosure, the monitor parameters of each piece of manufacturing equipment during each manufacturing process includes one or multiple physical parameters (such as pressure, temperature or flow velocity) and/or one or multiple chemical parameters (such as concentration or PH value). Each manufacturing process may require different monitor parameters. In an embodiment of the present disclosure, the user may edit the codebook data of the manufacturing equipment using the terminal device 40 (such as a computer, a smartphone or a tablet), but is not limited thereto.

The following Table 1 depicts a diagram of setting the codebook data in step 410 according to an embodiment of the present disclosure. The “SVID” column shows all parameter of a specific piece of equipment during a current manufacturing process. The “Mon” column is for setting monitor parameters (for example, “1” means selected as monitor parameter, while “0” means deselected as monitor parameter). The “FtrTp1” column is for setting the start point of collecting sampled data. The “FtrTp2” column is for setting the end point of collecting sampled data. The “LSL” column is for setting the lower limit of the data monitoring range, the “Target” column is for setting the target value of the data monitoring range, and the “USL” column is for setting the upper limit of the data monitoring range. In the embodiment depicted in Table.1, the required monitor parameters of the specific piece of equipment during the current manufacturing process are N2, SIH4 and H2 parameters, while NF3/AR/NH3/PH3/PRESSU parameters are not required to be monitored. Also, assuming that the length of the current manufacturing process is P seconds, the data monitoring range of the N2 parameter starts 3 seconds after the current manufacturing process begins and ends 6 seconds before the current manufacturing process finishes, wherein the data monitoring range of the N2 parameter has a total length of (P−9) seconds, a lower limit of 400, a target value of 600 and an upper limit of 800; the data monitoring range of the SIH4 parameter starts 7 seconds after the current manufacturing process begins and ends 5 seconds before the current manufacturing process finishes, wherein the data monitoring range of the SIH4 parameter has a total length of (P−12) seconds, a lower limit of 2375, a target value of 2500 and an upper limit of 2625; the data monitoring range of the H2 parameter starts 10 seconds after the current manufacturing process begins and ends 10 seconds before the current manufacturing process finishes, wherein the data monitoring range of the H2 parameter has a total length of (P−20) seconds, a lower limit of 6650, a target value of 7000 and an upper limit of 7350. The setting of the monitor parameters, the length of the data monitoring range, the lower limit of the data monitoring range, the target value of the data monitoring range or the upper limit of the data monitoring range may be based on personal experience of the user so as to reduce the false alarm rate. In another embodiment of the present disclosure, the weighting of each monitor parameter may also be set in the codebook data.

TABLE 1

| SVID | Mon | FtrTp1 | FtrTp2 | LSL | Target | USL |
|---|---|---|---|---|---|---|
| NF3 | 0 | 0 | 0 | | | |
| AR | 0 | 0 | 0 | | | |
| NH3 | 0 | 0 | 0 | | | |
| N2 | 1 | 3 | 6 | 400 | 600 | 800 |
| SIH4 | 1 | 7 | 5 | 2375 | 2500 | 2625 |
| PH3 | 0 | 0 | 0 | | | |
| H2 | 1 | 10 | 10 | 6650 | 7000 | 7350 |
| PRESSU | 0 | 0 | 0 | | | |

In step 420, each piece of manufacturing equipment is configured to upload its instant high-frequency data of all parameters to the historical data database DB2 and the edge computing server 20. In the present disclosure, the high-frequency data refers to multiple pieces of data collected based on a unit of time during a manufacturing process, such as multiple pieces of data measured every 5 seconds, every 2 seconds, every second, every 500 milliseconds, every 100 milliseconds or every 10 milliseconds, but is not limited thereto. In an embodiment, each piece of manufacturing equipment is configured to periodically upload its instant high-frequency data of all parameters to the historical data database DB2 and the edge computing server 20. In another embodiment, each piece of manufacturing equipment is configured to upload its instant high-frequency data of all parameters to the historical data database DB2 and the edge computing server 20 at predetermined time points.

In step 430, the modeling server 10 is configured to extract the historical high-frequency data of multiple monitor parameters of each piece of manufacturing equipment from the historical data database DB2 according to the codebook data. For example, the modeling server 10 may extract all instant data of the N2, SIH4 and H2 parameters in the current manufacturing process based on the codebook data depicted in Table 1. Since the NF3/AR/NH3/PH3/PRESSU parameters are not required to be monitored according to the codebook data depicted in Table. 1, the modeling server 10 does not extract the instant data of the NF3/AR/NH3/PH3/PRESSU parameters.

In step 440, the modeling server 10 is configured to perform data processing and data analyzing on the accessed historical high-frequency data for constructing the health model of each piece of the manufacturing equipment. More specifically, the above-mentioned data processing and data analyzing process includes a data pre-processing stage, a data characteristic extraction stage, and a data modeling stage. During the data pre-processing stage, the modeling server 10 is configured to perform data alignment, data filtering, data padding, function smoothing and data median curve calculation. The actual length of the same manufacturing process when performed on different pieces of manufacturing equipment may vary due to hardware and operational deviations, and the historical high-frequency data extracted by the modeling server 10 may thus have different lengths. In the present disclosure, the piece of data among the historical high-frequency data with a length equal to the median length of the historical high-frequency data is set as a standard piece of historical high-frequency data. Next, other pieces among the historical high-frequency data are stretched or compressed so as to be aligned with the standard piece of historical high-frequency data.

Assuming that the length L1 of a first piece among the historical high-frequency data is smaller than the standard length L0 of the standard piece of the historical high-frequency data, the length L1′ of the first piece of the historical high-frequency data may be increased to L0 after performing data stretching, thereby resulting zero-valued data on one or multiple locations of the stretched first piece of the historical high-frequency data. Under such circumstance, the modeling server 10 is configured to perform data padding using interpolation.

Assuming that the length L2 of a second piece among the historical high-frequency data is larger than the standard length L0 of the standard piece of the historical high-frequency data, the length L2′ of the second piece of the historical high-frequency data may be decreased to L0 after performing data compression, thereby resulting multiple data values on the same location of the compressed second piece of the historical high-frequency data. Under such circumstance, the modeling server 10 is configured to calculate the average value of the multiple data values.

Next, the modeling server 10 is configured to perform data filtering and data padding according to corresponding codebook data. In the embodiment of the codebook data depicted in Table 1, the user may set different lengths, different upper limits, different target values and different lower limits of the monitoring range for different monitor parameters. For example, since the data monitoring range of the N2 parameter starts 3 seconds after the current manufacturing process begins and ends 6 seconds before the current manufacturing process finishes, the modeling server 10 is configured to filter all data collected during the first 3 seconds and the last 6 seconds among the corresponding historical high-frequency data; since the data monitoring range of the SIH4 parameter starts 7 seconds after the current manufacturing process begins and ends 5 seconds before the current manufacturing process finishes, the modeling server 10 is configured to filter all data collected during the first 7 seconds and the last 5 seconds among the corresponding historical high-frequency data; since the data monitoring range of the H2 parameter starts 10 seconds after the current manufacturing process begins and ends 10 seconds before the current manufacturing process finishes, the modeling server 10 is configured to filter all data collected during the first 10 seconds and the last 10 seconds among the corresponding historical high-frequency data. Since zero-valued data may appear on one or multiple locations of the historical high-frequency data after performing data filtering, the modeling server 10 may perform data padding using interpolation. Next, the modeling server 10 may perform data smoothing on each piece of the pre-processed historical high-frequency data using functional data analysis techniques, thereby reducing stochastic variation of the historical high-frequency data and retaining curve trend. Last, the modeling server 10 may calculate the data median curve associated with each monitor parameter.

The data characteristic extraction stage includes the calculation of statistical eigenvalue and relevance eigenvalue. The statistical eigenvalue associated with each piece of the historical high-frequency data includes at least one of a median value, a maximum value, a minimum value, an average value and another statistical value of the historical high-frequency data. The relevance eigenvalue associated with each piece of the historical high-frequency data includes at least one of a mean directional outlyingness (MO) value of the historical high-frequency data, a variation of directional outlyingness (VO) value of the historical high-frequency data, a distance between the historical high-frequency data and a data median curve, and another suitable value. In an embodiment, the modeling server 10 may acquire the MO and VO associated with each piece of the historical high-frequency data by calculating the projection length of each piece of the historical high-frequency data. Last, the modeling server 10 may construct the health model of each piece of the manufacturing equipment based on the characteristics (statistical eigenvalue and relevance eigenvalue) of the historical high-frequency data associated with all monitor parameters of each piece of the manufacturing equipment. Since the statistical eigenvalue represents the individual characteristic of each piece of data and the relevance eigenvalue represents the variation of each piece of data in the data median curve, the health model constructed based on the statistical eigenvalue and the relevance eigenvalue is able to identify the relationships between multiple monitor parameters, thereby increasing the accuracy of the health model. In some embodiments, the modeling server 10 is further configured to acquire the upper-limit high-frequency data and the lower-limit high-frequency data of each manufacturing process and construct the health model of each piece of the manufacturing equipment based on the characteristics of the upper-limit high-frequency data, the lower-limit high-frequency data and the historical high-frequency data associated with all monitor parameters of each piece of the manufacturing equipment. More specifically, the modeling server 10 may shift the maximum value and the minimum value of the data median curve respectively to the upper limit value USL and the lower limit value LSL of the monitor range and simulate a Gaussian process with the shifted data median curve for acquiring the upper-limit high-frequency data and the lower-limit high-frequency data. Next, the modeling server 10 may calculate the statistical eigenvalue and relevance eigenvalue of the upper-limit high-frequency data and the lower-limit high-frequency data.

In step 450, the modeling server 10 is configured to upload the codebook data and the health model of each piece of manufacturing equipment to the model database DB3. In step 460, the edge computing server 20 is configured to compare the health model of each piece of manufacturing equipment with the corresponding instant high-frequency data uploaded by each piece of manufacturing equipment, thereby generating the health index score of each piece of manufacturing equipment and storing all health index scores in the health index database DB4. More specifically, after each piece of manufacturing equipment uploads the instant high-frequency data of all parameters to the edge computing server 20 in step 420, the edge computing server 20 may perform parameter clustering using principal components analysis (PCA) so as to simplify a large data set into a smaller set while still maintaining significant patterns and trends. Parameter clustering reduces data dimensionality and the impact of stochastic variation, thereby allowing the user to observe main variations of the sample more easily. Next, based on the mean and covariance of data matrix acquired after PCA, the edge computing server 20 may calculate the instant high-frequency data of each parameter group associated with each piece of manufacturing equipment and a Mahalanobis distance associated with the corresponding health model, thereby constructing a Hotelling's T-square test for acquiring a corresponding T-square value. The edge computing server 20 may perform non-linear transformation on the T-square value of each parameter group associated with each piece of manufacturing equipment and the upper limit value USL of the monitor range (such as e^{(T-square/USL)×log(0.9)}) so as to provide the health index score of each piece of manufacturing equipment using 0-100 points, wherein 0 point is the lowest score and 100 points is the highest score. In the present disclosure, the representation of the health index score after performing non-linear transformation is not limited to 0-100 points. In some embodiments, the edge computing server 20 may include the weighting of each monitor parameter when performing PCA, but is not limited thereto. The weighting of each monitor parameter may be acquired from the codebook data set by the user, but is not limited thereto. In some embodiments, the weighting of each monitor parameter may be automatically acquired based on the ratio of the difference between the maximum and the minimum of the historical high-frequency data to the difference between the upper limit value USL and the lower limit value LSL of the codebook data. For example, regarding the monitor parameter N2, assuming that its historical high-frequency data has a maximum value of 750 and a minimum value of 430, and that its codebook data has an upper limit value USL of 800 and a lower limit value LSL of 400, the weighting of the monitor parameter N2 may be automatically set to (750−430)/(800−400).

In step 470, the analyzing server 30 is configured to extract the health index score of each piece of manufacturing equipment from the health index database DB4, determine whether the health index score of each piece of manufacturing equipment is qualified, and perform a reason analysis in response to an unqualified health index score. For example, the control limit of the health index score may be set to 90 points in the present disclosure. If the health index score of a specific parameter group associated with a specific piece of manufacturing equipment is lower than 90 points, the analyzing server 30 may determine that the health index score of the specific piece of manufacturing equipment is not qualified and perform a reason analysis. Next, the analyzing server 30 may transmit the analyzing results to the terminal device 40 so that the user may maintain/adjust the specific piece of manufacturing equipment accordingly. In another embodiment, the analyzing server 30 is further configured to collect multiple maintenance records for determining whether the health model of each piece of manufacturing equipment is still applicable. If the health index score of the specific parameter group is still not qualified after performing maintenance on the specific piece of manufacturing equipment, the analyzing server 30 may instruct the modeling server 10 to rebuild a new health model for the specific piece of manufacturing equipment.

In conclusion, the present disclosure provides a system and a method of assessing health status of manufacturing equipment by monitoring the instant status of manufacturing process at each station. The present disclosure may include user experience in the health model construction process when setting monitor parameters, the monitor range, and the lower limit/target value/upper limit of the monitor range, thereby reducing the rate of false alarm. Also, the present disclosure may extract the characteristics of manufacturing data associated with each piece of manufacturing equipment using functional data analysis techniques, thereby constructing the health model of each piece of manufacturing equipment. On the other hand, the present disclosure combine statistical multi-variable and machine learning so as to integrate multiple characteristics of multiple monitor parameters into a single health index, thereby allowing the user to easily identify the parameters relevant to unstable manufacturing processes.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A system of assessing health status of manufacturing equipment, comprising:
a codebook database configured to store a codebook data which is associated with multiple monitor parameters of a piece of manufacturing equipment during each manufacturing process;
a historical data database configured to store instant high-frequency data of all parameters of the piece of manufacturing equipment, thereby providing historical high-frequency data of all parameters of the piece of manufacturing equipment;
a modeling server configured to access the historical high-frequency data of the multiple monitor parameters from the historical data database according to the codebook data and extract characteristics of the historical high-frequency data of the multiple monitor parameters for constructing a health model of the piece of manufacturing equipment; and
an edge computing server configured to analyze the instant high-frequency data uploaded by the piece of manufacturing equipment during a current manufacturing process and the health model on a real-time basis, thereby generating a health index score of the piece of manufacturing equipment during the current manufacturing process.

2. The system of claim 1, wherein the modeling server is further configured to:
calculate a statistical eigenvalue and a relevance eigenvalue associated with the historical high-frequency data of the multiple monitor parameters; and
construct the health model of the piece of manufacturing equipment based on the statistical eigenvalue and the relevance eigenvalue.

3. The system of claim 1, further comprising an analyzing server configured to:
determine whether the health index score of the piece of manufacturing equipment is qualified; and
perform a reason analysis when determining that the health index score of the piece of manufacturing equipment is not qualified.

4. The system of claim 1, further comprising:
a model database for storing the health model of the piece of manufacturing equipment.

5. The system of claim 4, wherein:
the modeling server, the analyzing server and the codebook database are disposed on a cloud; and
the edge computing server, the historical data database, the model database and the piece of manufacturing equipment are disposed on a factory site.

6. The system of claim 4, wherein:
the modeling server, the analyzing server, the codebook database and the historical data database are disposed on a cloud; and
the edge computing server, the model database and the piece of manufacturing equipment are disposed on a factory site.

7. The system of claim 4, wherein:
the modeling server, the analyzing server, the edge computing server, the codebook database, the historical data database, the model database and the piece of manufacturing equipment are disposed on a same factory.

8. The system of claim 1, further comprising:
a health index database for storing the health index score of the piece of manufacturing equipment.

9. The system of claim 1, wherein the modeling server is further configured to:
acquire an upper-limit high-frequency data and a lower-limit high-frequency data of each manufacturing process; and
construct the health model of each piece of the manufacturing equipment based on a characteristic of the upper-limit high-frequency data, the lower-limit high-frequency data and the historical high-frequency data associated with all monitor parameters of each piece of the manufacturing equipment.

10. The system of claim 9, wherein:
the codebook data includes a monitor range of each monitor parameter of the piece of manufacturing equipment during each manufacturing process; and
the modeling server is further configured to:
calculate a data median curve associated with each monitor parameter of the piece of manufacturing equipment;
shift a maximum value and a minimum value of the data median curve respectively to an upper limit value and a lower limit value of the data monitor range; and
simulate a Gaussian process with the shifted data median curve for acquiring the upper-limit high-frequency data and the lower-limit high-frequency data.

11. A method of assessing health status of manufacturing equipment, comprising:
setting a codebook data associated with multiple monitor parameters of a piece of manufacturing equipment during each manufacturing process;
storing instant high-frequency data of all parameters of the piece of manufacturing equipment for providing historical high-frequency data of all parameters of the piece of manufacturing equipment;
accessing the historical high-frequency data of the multiple monitor parameters from the historical data database according to the codebook data and extracting characteristics of the historical high-frequency data of the multiple monitor parameters for constructing a health model of the piece of manufacturing equipment; and
analyzing the instant high-frequency data uploaded by the piece of manufacturing equipment during a current manufacturing process and the health model on a real-time basis for generating a health index score of the piece of manufacturing equipment during the current manufacturing process.

12. The method of claim 11, further comprising:
performing a data preprocessing on the historical high-frequency data of the multiple monitor parameters before extracting the characteristics of the historical high-frequency data of the multiple monitor parameters.

13. The method of claim 12, wherein:
performing the data preprocessing includes performing a data alignment, a data filtering, a data padding, and a function smoothing and a data median curve calculation on the accessed historical high-frequency data of the multiple monitor parameters.

14. The method of claim 11, further comprising:
calculating a statistical eigenvalue and a relevance eigenvalue of the historical high-frequency data of the multiple monitor parameters; and
constructing the health model of the piece of manufacturing equipment based on the statistical eigenvalue and the relevance eigenvalue.

15. The method of claim 14, wherein:
the statistical eigenvalue includes at least one of a median value, a maximum value, a minimum value and an average value of the historical high-frequency data of the multiple monitor parameters.

16. The method of claim 14, wherein:
the relevance eigenvalue includes at least one of a mean directional outlyingness (MO) value associated with the historical high-frequency data of the multiple monitor parameters, a variation of directional outlyingness (VO) value associated with the historical high-frequency data of the multiple monitor parameters, and a distance between a data median curve and the historical high-frequency data of the multiple monitor parameters.

17. The method of claim 16, further comprising:
acquiring the MO value and the VO value associated with the historical high-frequency data of the multiple monitor parameters by calculating a projection length of each piece of the historical high-frequency data.

18. The method of claim 11, further comprising:
determining whether the health index score of the piece of manufacturing equipment is qualified; and
performing a reason analysis when determining that the health index score of the piece of manufacturing equipment is not qualified.

19. The method of claim 11, further comprising:
acquiring an upper-limit high-frequency data and a lower-limit high-frequency data of each manufacturing process; and
constructing the health model of each piece of the manufacturing equipment based on a characteristic of the upper-limit high-frequency data, the lower-limit high-frequency data and the historical high-frequency data associated with all monitor parameters of each piece of the manufacturing equipment.

20. The method of claim 19, further comprising:
setting the codebook data to include a monitor range of each monitor parameter of the piece of manufacturing equipment during each manufacturing process;
calculating a data median curve associated with each monitor parameter of the piece of manufacturing equipment;
shifting a maximum value and a minimum value of the data median curve respectively to an upper limit value and a lower limit value of the data monitor range; and
simulate a Gaussian process with the shifted data median curve for acquiring the upper-limit high-frequency data and the lower-limit high-frequency data.
